(19) United States
(12) Patent Application Publication
(10) Pub. No.: US 2014/0337478 A1
(43) Pub. Date: Nov. 13, 2014

(54) PEER-TO-PEER NETWORK COMMUNICATIONS

(71) Applicant: SOCIAL COMMUNICATIONS COMPANY, Eugene, OR (US)

(72) Inventors: Joseph Altmaier, North Liberty, IA (US); Robert J. Butler, Coralville, IA (US)

(73) Assignee: Social Communications Company, Eugene, OR (US)

(21) Appl. No.: 13/889,324

(22) Filed: May 7, 2013

(51) Int. Cl. H04L 29/08

(52) U.S. Cl. CPC H04L 67/32
USPC 709/219

(57) ABSTRACT

In order to capture additional network address information that potentially is useful for establishing peer-to-peer connections, client nodes collect network address information from one another. In some examples, the client nodes perform their own independent asymmetric discovery for network addresses that may be sent to a server node for distribution to other client nodes and used to establish peer-to-peer connections between client nodes. In this way, the client nodes are able to obtain network address information that otherwise might not be discoverable by the sever node and thereby increase the number of direct peer connections, improve the robustness of the session establishment process, and reduce the network address collection and peer node matchmaking burdens on the server node.

### CROSS-REFERENCE TO RELATED APPLICATIONS

This application relates to co-pending U.S. patent application Ser. No. 12/825,512, filed Jun. 29, 2010, the entirety of each of which is incorporated herein by reference.

### BACKGROUND

A peer-to-peer network includes a distributed network of interconnected peer nodes that communicate with one another over peer connections. Some peer nodes may connect to other peers through a gateway, such as a network address translator (NAT) device, a firewall, or a virtual private network (VPN). Some gateways impede the ability of peer nodes to establish connections across the gateway. For example, a gateway may block incoming communications sourced from an external network address and sent to a destination peer node behind the gateway unless the destination peer node previously sent data to that external network address. In an effort to address this issue, a peer node behind a gateway may communicate with a STUN (Simple Traversal of UDP (User Datagram Protocol) through NAT (Network Address Translation) server to determine the public network address used by the gateway and then share the public address with external peer nodes for their use in attempting to communicate with the internal peer node. In addition, peer nodes may use a matching server or public domain peer to share the self-reported peer node addresses that may used by the peer nodes to send messages to each other so that gateway devices will pass the incoming messages from the other peers. What are needed are improved systems and methods for peer-to-peer network communications.

### DESCRIPTION OF DRAWINGS

FIG. 1 is a diagrammatic view of an example of a network communications environment that includes client nodes communicating with a network service over respective network connections and sessions.

FIG. 2 is a flow diagram of an example of a method of collecting network address information for provisioning peer-to-peer connections between client nodes.

FIG. 3 is a flow diagram of an example of a method of collecting network address information for provisioning peer-to-peer connections between client nodes.

FIG. 4 is a flow diagram of an example of a method of provisioning peer-to-peer connections between client nodes.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. DEFINITION OF TERMS

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “data file” is a block of information that durably stores data for use by a software application.

The term “computer-readable medium” (also referred to as “memory”) refers to any tangible, non-transitory medium capable storing information (e.g., instructions and data) that is readable by a machine (e.g., a computer). Storage devices suitable for tangibly embodying such information include, but are not limited to, all forms of physical, non-transitory computer-readable memory, including, for example, semiconductor memory devices, such as random access memory (RAM), EPROM, EEPROM, and Flash memory devices, magnetic disks such as internal hard disks and removable hard disks, magneto-optical disks, DVD-ROM/RAM, and CD-ROM/RAM.

A “data sink” (referred to herein simply as a “sink”) is any of a device (e.g., a computer), part of a device, or software that receives data.

A “data source” (referred to herein simply as a “source”) is any of a device (e.g., a computer), part of a device, or software that originates data.

A “network node” (also referred to simply as a “node”) is a physical junction or connection point in a communications network. Examples of network nodes include, but are not limited to, a terminal, a computer, and a network switch. A “server node” is a network node that responds to requests for information or service. A “client node” is a network node that requests information or service from a server node.

A “network address” is protocol-specific coded representation of a source or destination of a message and is used to uniquely identify a network node on a network.

A “socket” is a network communications endpoint. An application program typically can create a socket for communicating over a network by calling a network services application programming interface (API) of the operating system hosting the application program.

A “protocol port” (or simply “port”) is an application-specific or process-specific software construct serving as a communications endpoint within a network node. A transport protocol assigns unique numbers to ports in order to distinguish among different endpoints within a network node.

A “network connection” is a link between two communicating network nodes. A “connection handle” is a pointer or identifier (e.g., a uniform resource identifier (URI)) that can be used to establish a network connection with a network resource. A “network communication” can include any type of information (e.g., text, voice, audio, video, electronic mail message, data file, motion data stream, and data packet) that is transmitted or otherwise conveyed from one network node to another network node over a network connection.

A “session” is a logical connection between two endpoint network nodes (referred to herein as “session partners”) that provides a context for exchanging messages between the two network nodes from the time the session is established to the time that is it torn down. From the perspective of a given network node, a session is transported on a transport stream, where the transport stream may or may not be addressed to the session partner. For example, a transport stream may be addressed to a proxy server that bridges the session to the session partner. A “peer-to-peer” (P2P) session is a session between two network nodes each of which can initiate the P2P session and act as a client and a server during the P2P session.

A “universally unique identifier” (also referred to as a “globally unique identifier,” or GUID) is a number that is used to uniquely identify an object in a computer system or on a network (e.g., the internet). A universally unique identifier is generated without requiring a centralized service or authority to administer. A universally unique identifier typically is an octet string of 16 octets (128 bits). Depending on the specific mechanism used to generate a universally unique identifier, the universally unique identifier either is guaranteed to be different or is at least extremely likely to be different from any other universally unique identifier. A “well-known UUID” is a UUID that is used to reliably identify persistent objects across a network.

A “realtime data stream” is data that is structured and processed in a continuous flow and designed to be received with no delay or only imperceptible delay. Realtime data streams include digital representations of voice, video, user movements, facial expressions and other physical phenomena, as well as data within the computing environment that may benefit from rapid transmission, rapid execution, or both rapid transmission and rapid execution, including for example, avatar movement instructions, text chat, realtime data feeds (e.g., sensor data, machine control instructions, transaction streams and stock quote information feeds), screen shares, and file transfers.

As used herein, the term “includes” means includes but not limited to, the term “including” means including but not limited to. The term “based on” means based at least in part on.

### II. PEER-TO-PEER NETWORK COMMUNICATIONS

The examples that are described herein provide systems and methods of peer-to-peer communications in which peer nodes participate in collecting network address information from other peer nodes. The peer nodes send the collected network address information to a server node for distribution among the peer nodes for use in establishing peer-to-peer network connections. In this way, the examples that are described herein increase the robustness of the session establishment process and reduce the network address collection and peer node matchmaking burdens on the server node.

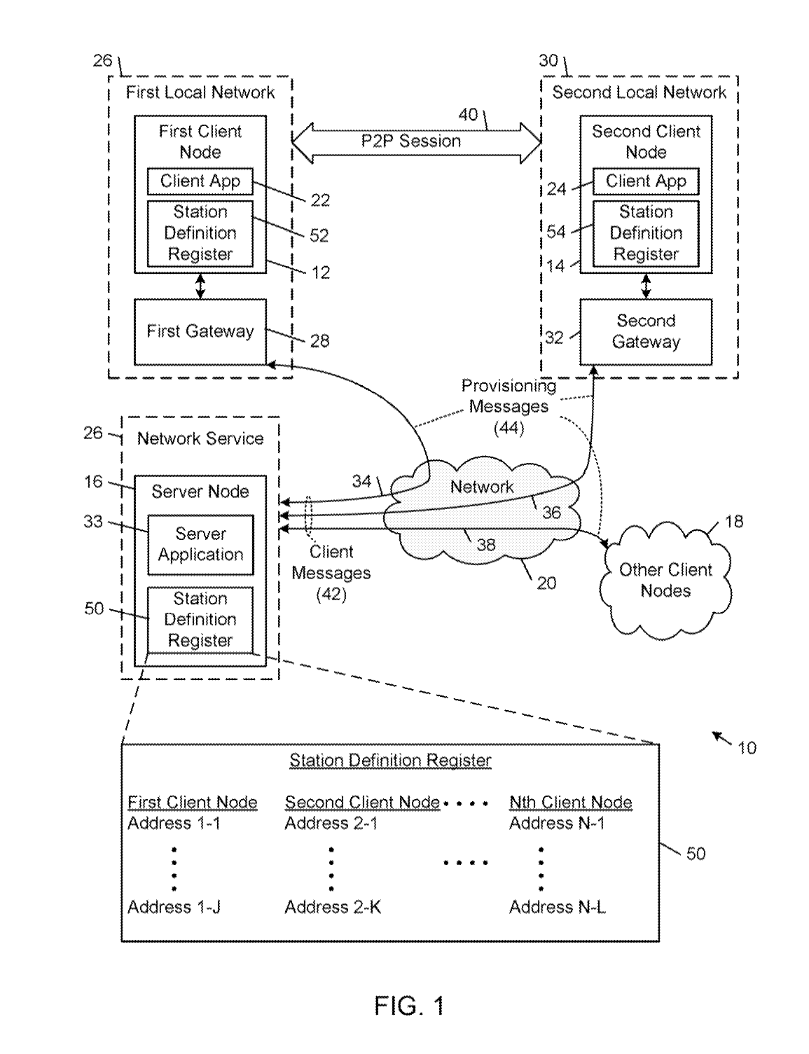

FIG. 1 shows an embodiment of an exemplary network communications environment 10 that includes a first client node 12, a second client node 14, a server node 16, and other client nodes 18 that are interconnected by a network 20, which includes for example any of a local area network (LAN), a metropolitan area network (MAN), and a wide area network (WAN) (e.g., the internet). The server node 16 runs a server application 33 that provides a network service 22 supporting realtime communications between the client nodes 12, 14, 18. In some examples, the network service 22 is a synchronous conferencing service that supports one or more types of synchronous communications between the client nodes 12, 14 (e.g., instant messaging (e.g., text chat), audio conferencing, video conferencing, application sharing, and file sharing).

Each of the client nodes 12, 14, 18 typically includes a tangible, non-transitory computer-readable memory, a processor, and input/output (I/O) hardware (including a display). The processor executes at least one communications application 22, 24 that is stored in the memory. The first client node 12 is node of a first local network 26 that connects to the network 20 through a first gateway 28. The second client node 14 is node of a second local network 30 that connects to the network 20 through a second gateway 32. The first and second gateways 28, 32 may be, for example, a network address translator (NAT) device, a firewall, or a virtual private network (VPN).

Each of the client nodes 12, 14, 18 has a respective set of one or more sources and a respective set of one or more sinks. Each source is a device or component that originates data of a particular data stream content type and each sink is a device or component that receives data of a particular data stream content type. A source and a sink of the same data stream content type are referred to herein as being “complementary.” Exemplary sources include an audio source (e.g., an audio capture device, such as a microphone), a video source (e.g., a video capture device, such as a video camera), a chat source (e.g., a text capture device, such as a keyboard), a motion data source (e.g., a pointing device, such as a computer mouse), and other sources (e.g., file sharing source or a source of a customized real-time data stream). Exemplary sinks include an audio sink (e.g., an audio rendering device, such as a speaker or headphones), a video sink (e.g., a video rendering device, such as a display monitor), a chat sink (e.g., a text rendering device, such as a display monitor), a motion data sink (e.g., a movement rendering device, such as a display monitor), and other sinks (e.g., a printer for printing shared files, a device for rendering real-time data streams different from those already described, or software that processes real-time streams for analysis or customized display). Each source has an active state in which the source is available for originating data and an inactive state in which the source is not available for originating data. Likewise, each sink has an active state in which the sink is available for receiving data and an inactive state in which the sink is not available for receiving data. Users operating the client nodes 12, 14, 18 typically control the states of the sources and sinks via controls provided by the client applications 22, 24. For example, the client applications 22, 24 typically provide user controls for turning on/off the local microphones and the local speakers (e.g., headsets) on the client nodes 12, 14, 18.

In some examples, the client nodes 14, 16, 18 share data in accordance with publish/subscribe model, which typically is connectionless. In these embodiments, the client nodes 12, 14, 18 subscribe to only the data they need. The server node 16 determines what channels are needed by each of the client nodes 12, 14, 18 based on the respective states (i.e., active or inactive) of their sources and sinks. The server application 33 sends to each of the client nodes 12, 14, 18 respective publish messages indicating what information streams are available for that client node, tagging each stream with a GU ID handle. Each of the client applications 22, 24 operating on each client node may subscribe to zero or more of the channels. A client application 22, 24 that subscribes to a channel registers with a local stream transport service to receive notification of channel state changes and channel records as they arrive. Each of the client nodes then subscribes to the desired channels from the other client nodes using well-known channel GUIDs that are specified by the server application 33. Any changes to server data for a particular channel will be sent as definition records to all the client nodes that have subscribed to that channel. Exemplary methods of sharing data according to a publish/subscribe model and examples of a stream transport service are described in U.S. application Ser. No. 12/825,512, filed Jun. 29, 2010.

Sessions between the network nodes can be established over any type of serial communications protocol stream (e.g., UDP, TCP, HTTP, and PPP). In some embodiments, a stream is a bi-directional UDP socket between two network nodes defined by two IP address/port pairs, and a transport GUID. A stream supports sessions of channels. A session is a logical node-to-node connection. Sessions transport channels for the two nodes. Sessions may pass through one or more proxy nodes and are transported over streams that may contain multiple sessions.

In the example shown in FIG. 1, the client nodes 12, 14, 18 and the server node 16 communicate with each other over respective pair-wise sessions 34, 36, 38, and 40. In this example, each of the client nodes 12, 14, 18 establishes a respective server session 34-38 with the server node 16, and the first and second client nodes 12, 14 establish a peer-to-peer (P2P) session 40 with one another. The sessions 34-40 are divided logically into channels that are identified by respective channel identifiers. Exemplary types of channels include session channels, station channels, and content channels. Session channels are designated for carrying data (e.g., StreamStats, Pings, and Keepalive messages) relating to session management tasks. Station channels are designated for carrying data relating to network address resolution tasks. Content channels are designated for carrying content data (e.g., audio data, chat data, and screen share data). Examples of methods by which the server sessions 34, 36, 38 may be established are described in U.S. application Ser. No. 12/825,512, filed Jun. 29, 2010.

In the server sessions 34, 36, 38, the client nodes 12, 14, 18 send, for example, login requests, peer address information, and other messages 42 to the server node 16, and the server node 16 sends to the client nodes 12, 14, 18 provisioning messages 44 that configure the client nodes 12, 14, 16 to interconnect respective data streams between active ones of their complementary sources and sinks in accordance with switching rules specified in the server application 33. In the P2P session 40, the client nodes 12, 14 publish local publish and subscribe channels and send content data to one another.

Network authentication typically is made once each time the communications applications 22, 24 are launched on the client nodes 12, 14, and 18. In this process, the server node 16 receives from each client application a login message containing a source address of the client node. The source address typically is embedded in a header of the packet containing the login message. The login message typically includes a Station ID that was assigned to the client node at the time the communications application was installed on the client node. In response to the login message, the server node 16 authenticates the client node. After authenticating the client nodes, the server node 16 extracts the source addresses from the login messages and incorporates the extracted source addresses into respective station definitions of the client nodes, where each station definition includes a persistent Station ID that uniquely identifies the associated network node and a set of one or more addresses (e.g., {IP address, Socket Port, Protocol ID} entries) that are associated with the respective network node. In the example shown in FIG. 1, the server node 16 stores the client station definitions in a server Station Definition Register 50. The server node 16 then sends to each client node the station definitions of the client node and the server node 16, and a definition of a session between the client node and the server network node 16. The session definition includes a Session ID that uniquely identifies a respective session, the Station ID of the client node, the Station ID of the server node 16, a Transport ID that identifies the transport protocol to be used for the respective session, and an Encryption ID that identifies an encryption protocol to be used for the respective session.

In response to receipt of the station definitions from the server node 16, each of the client nodes 12, 14, 18 stores the station definitions of the client node and the server network node 16 in a respective client Station Definition Register 52, 54 (see FIG. 1) and establishes a session with the server network node 16 based on the session definition. After the client nodes 12, 14, 18 have established a session with the server node 16, the server node 16 provisions respective pairs of the client nodes for communications in accordance with switching rules defined in the server application 33. In this process, the server node 16 searches the source and sink state data that the server node 16 maintains for each of the client nodes 12, 14, 18 for complementary active sources of sinks of each data stream content type that is permitted by the server application 33, and determines each pair of client nodes that have at least one active set of complementary sources and sinks between them. Examples of active sets of complementary sources and sinks, include an active microphone on one client node and an active speaker on another client node, an active screen sharing by one client node and an active screen viewing by another client node, and a respective active chat window on each of two client nodes. For each of the determined pairs of client nodes, the server node 16 sends to each of the constituent client nodes of the pair a respective session definition defining a respective peer-to-peer session over a network connection between the constituent client nodes of the pair and definitions of the channels that are available on the session.

The constituent client nodes of each pair attempt to establish a peer-to-peer session over a respective network connection based on the session definition. In this process, the client application on each client node uses the session definition to determine the Station ID of the other session partner client node, and then looks up the locally stored station definition of the other session partner client node in the client Station Definition Register to find a set of one or more addresses for negotiating respective network connections with the other network node. After determining the one or more addresses that are associated with the session partner's Station ID, the client application on each client node transmits to each address (e.g., IP/Port pair) a StreamStats message on the Station Channel of the client network node (i.e., with the Station ID of the local network node as the Channel ID). This transmission burst to each of the session partner addresses typically is repeated with an exponentially-increasing back-off delay starting at, for example, 50 milliseconds (ms) and increasing at a rate of 1.5 times after each burst until a value exceeding 3 seconds is reached, at which point bursts occur every 3 seconds. In some embodiments, each StreamStats message is a STRAW packet that has a Channel ID that identifies the channel (e.g., station channel or session channel) and a payload that consist of a SODA record that has a SODA ID field and a dropped packets count field, as described in U.S. application Ser. No. 12/825,512, filed Jun. 29, 2010.

Typically, the session partners concurrently send respective StreamStats messages to each other until one or both of the session partners receive a StreamStats message. When any StreamStats message is received from a first session partner (identified by the Channel ID), the second session partner extracts the network address (e.g., the IP/Port address) associated with the first session partner from the StreamStats message. In some embodiments, the client application on the second session partner extracts the address associated with the StreamStats message by calling a service through a networking application programming interface (API) of a computer operating system running on the second session partner. For example, in a network node running the Windows® operating system, the address extraction functionality is provided through a service contained within the Winsock API.

After extracting the network address associated with the session partner from the StreamStats message, the second session partner sends a StreamElect message back to the extracted address on the Station Channel for the second session partner. Each StreamElect message is a STRAW packet has a payload consisting of a SODA record with SODA ID field and a total length field. The second session partner sends the StreamElect message on its Station channel by using its Station ID as the Channel ID of the STRAW packet. In some examples, a client node may send a StreamElect message to the session partner indirectly through the server node 16 so that the session partner will receive the StreamElect message even if the session partner has not yet resolved an address for the client node. For example, after receiving a StreamStats message from the second client node 14, the first client node 12 may send a StreamElect message to the sever node 16, which then encapsulates the StreamElect message to the second client node 14 marked with the station address of the first client node 12.

When the second session partner receives a StreamElect message from the first session partner, the second session partner binds the first session partner to the network address that is extracted from the received StreamElect message. In this process, the client application on the second session partner promotes the address that is extracted from the StreamElect message to the “net address current” by setting a bit in the locally stored definition of the first session partner. Setting the net address current bit marks that address as valid for use by the second session partner to establish a session with the first session partner. At this point the network address of the first session partner has been resolved and a transport stream has been established between the first and second session partners. The process of sending StreamStats messages and waiting for receipt of a StreamElect message from the first session partner ensures that the first session partner has received a message from the second session partner sent to the net address current and that the second session partner has received a message by the first session partner from the net address current.

In some examples, the session partners continue to perform the network address resolution process described above even after each session partner has determined a network address for the other session partner. In this process, each session partner periodically (e.g., every ten seconds) sends StreamStats messages to each other at every known address for the session partner and sends back StreamElect messages responsive to the StreamStats messages that it receives.

Examples of methods by which the client nodes negotiate a link with each other using StreamStats and StreamElect messages are described in U.S. application Ser. No. 12/825,512, filed Jun. 29, 2010.

As explained above, the server node 16 extracts source address information for the client nodes from the login messages that it receives from the client applications 22, 24. The inventors have observed that this process does not capture all of the client node network address information that is available and potentially useful for establishing peer-to-peer connections. For example, some client nodes may be associated with more than one public network address (e.g., a public IP address of the client node and a public IP address of a VPN on which the client node is located) but the server node 16 is able to discover only one of the public network addresses. In addition, client nodes that are behind the same gateway (e.g., a NAT device, a firewall, or a VPN) may be able to communicate using local network addresses that are not discoverable by the server node 16. In order to capture additional network address information that potentially is useful for establishing peer-to-peer connections, the client nodes also collect network address information from one another. In this process, the client nodes perform their own independent asymmetric discovery for network addresses that may be sent to the server node 16 for distribution to other client nodes and used to establish peer-to-peer connections between client nodes. In this way, the client nodes are able to obtain network address information that otherwise might not be discoverable by the sever node 16 and thereby increase the number of direct peer connections, improve the robustness of the session establishment process, and reduce the network address collection and peer node matchmaking burdens on the server node 16.

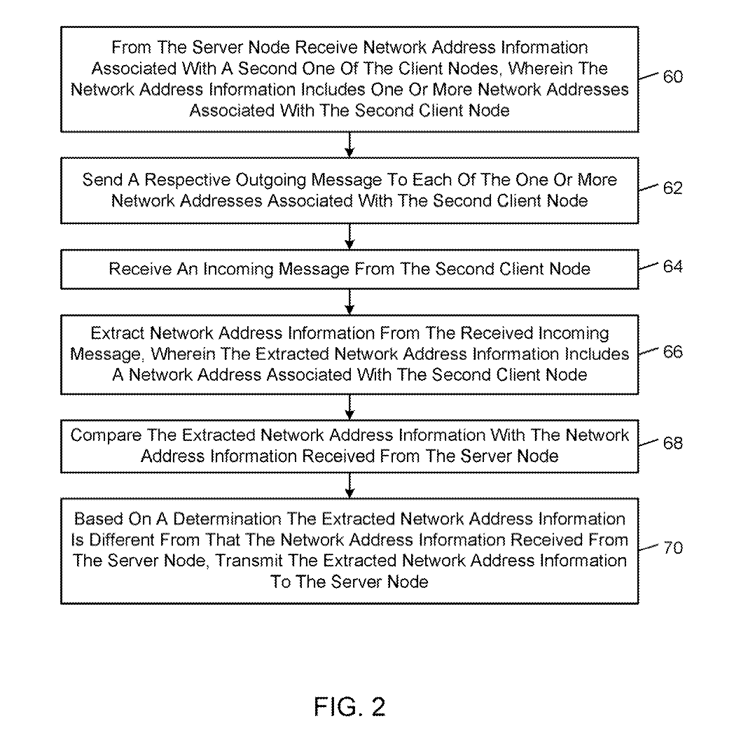

FIG. 2 shows an example of a method by which the first client node 12 collects network address information that is associated with the second client node 14. In this method, the first client node 12 receives from the server node 16 network address information associated with the second client node 14, where the network address information includes one or more network addresses associated with the second client node 14 (FIG. 2, block 60). The first client node 12 sends a respective outgoing message to each of the one or more network addresses associated with the second client node 14 (FIG. 2, block 62). In some examples, a client node will send a StreamStats message on its own station ID channel to each of the addresses associated with the second client node to which it has been provisioned to establish a peer-to-peer connection. The first client node 12 receives an incoming message from the second client node 14 (FIG. 2, block 64) and extracts network address information from the received incoming message, where the extracted network address information includes a network address associated with the second client node 14 (FIG. 2, block 66). In some examples, the first client node receives a StreamStats message on the Station ID Channel of the second client node and extracts the source address associated with the StreamStats message. The first client node 12 compares the extracted network address information with the network address information received from the server node 16 (FIG. 2, block 68). Based on a determination the extracted network address information is different from that the network address information received from the server node, the first client node 12 transmits the extracted network address information to the server node 16 (FIG. 2, block 70). The server node 16 then may incorporate the new network address information into the server Station Definition Register 50 for use in provisioning peer-to-peer connections between client nodes.

In some examples, based on a determination the extracted network address information is different from that the network address information received from the server node 16, the first client node 12 incorporates the extracted network address information associated with the second client node 14 in the client Station Definition Register 52. In this way, the first client will use the extracted network address information along with all the other network address information for the second client node 14 in the client Station Definition Register 52 in the next attempt to establish a peer-to-peer connection with the second client node 14.

In some examples, based on a determination the extracted network address information is different from that the network address information received from the server node 16, the first network node 12 transmits all the network address information in the client Station Definition Register 52 to the server node 16.

In some examples, the second client node 14 concurrently performs the method of FIG. 2 independently of the first client node 12. In this process, the second client node 14 receives network address information associated with the first client node 12 from the server node 16, where the network address information includes one or more network addresses associated with the first client node 12. The second client node 14 sends a respective outgoing message to each of the one or more network addresses associated with the first client node 12. The second client node 14 receives an incoming message from the first client node 12. The second client node 14 extracts network address information from the received incoming message, where the extracted network address information includes a network address associated with the first client node 12. The second client node 14 compares the extracted network address information with the network address information received from the server node 16. Based on a determination that the extracted network address information is different from that the network address information received from the server node 16, the second client node 14 transmits the extracted network address information to the server node 16.

Depending on the network architecture between the first and second client nodes 12, 14, the source address of the incoming message received from the second client node 14 (FIG. 2, block 64) may be the same as or different from the viable network address to which the first client node 12 sent the outgoing message that was received by the second client node (FIG. 2, block 62).

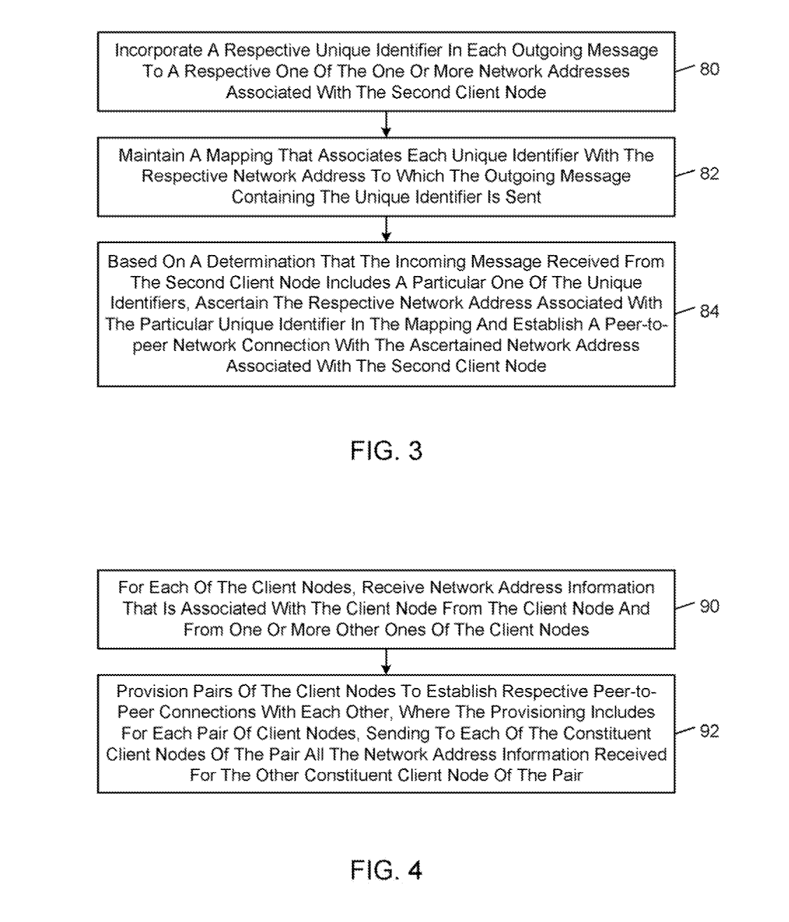

FIG. 3 shows an example of a method by which the first client node 12 determines which of the network addresses used to send the outgoing messages to the second client node 14 (FIG. 2, block 62) was viable for communicating with the second client node 14 without regard to the source network address of the incoming message received from the second client node 14 (FIG. 2, block 64).

In accordance with the method of FIG. 3, the first client node 12 incorporates a respective unique identifier in each outgoing message (e.g., a StreamStats message) addressed to a respective one of the one or more network addresses associated with the second client node 14 (FIG. 3, block 80). The unique identifier may be, for example, a GUID, a counting number, or other identifier that is unique to the current session establishment transaction between the first and second client nodes 12, 14. The first client node 12 maintains a mapping that associates each unique identifier with the respective network address to which the outgoing message containing the unique identifier is sent (FIG. 3, block 82). If any of the outgoing messages reaches the second client node 14, the second client node 14 extracts the unique identifier from each outgoing message received and incorporates it into a respective message (e.g., a StreamElect message) that the second client node 14 sends to the first client node 12. Based on a determination that an incoming message received from the second client node includes a particular one of the unique identifiers, first client node 12 ascertains the respective network address associated with the particular unique identifier in the mapping and establishes a peer-to-peer network connection with the ascertained network address associated with the second client node (FIG. 3, block 84). The first client node 12 may then bind the second client node 14 to the ascertained network address and inform the server node 16 that the ascertained network address is viable for communications with the second client network node 14.

FIG. 4 shows a method by which the server node 16 uses the address information collected by the client nodes in provisioning the client nodes for establishing peer-to-peer connections. For each of the client nodes, the server node 16 receives network address information associated with the client node from (i) the client node and (ii) one or more other ones of the client nodes (FIG. 4, block 90). The server node 16 provisions pairs of the client nodes to establish respective peer-to-peer connections with each other, where the provisioning includes for each pair of client nodes, sending to each of the constituent client nodes of the pair all the network address information received for the other constituent client node of the pair (FIG. 4, block 90).

In some examples, the server node 16 receives first network address information associated with the first client node from a first one of the client nodes, receives second network address information associated with the second client node from a second one of the client nodes, and receives third network address information associated with the first client node from a third one of the client nodes. In some of these examples, each of the first, second, and third network address information respectively includes at least one of a public network address of the first client node, a local network address of the first client node, and a virtual private network address of the first client node. In some of these examples, each of the first, second, and third network address information includes a respective connectionless transport protocol address and a respective protocol port identifier for a protocol port on the client node. In some of these examples, the process of provisioning the first client node involves sending the first client node a first station identifier that uniquely identifies the second client node, and the process of provisioning the second client node involves sending the second client node a second station identifier that uniquely identifies the first client node. In some of these examples, the server node 16 also receives additional network address information associated with the first client node from ones of the client nodes other than the first and second client nodes, and the process of provisioning the second client node includes sending the additional network address information to the second client node. In some of these examples, the server node sends the second network address information and the third network address information to the third client node to provision the third client node to establish a peer-to-peer network connection with the first client node.

### III. CONCLUSION

Other embodiments are within the scope of the claims.

1. A method in a network communication environment comprising at least one server node supporting realtime communications between client nodes, the method comprising by a first one of the client nodes:
from the server node receiving network address information associated with a second one of the client nodes, wherein the network address information comprises one or more network addresses associated with the second client node;
sending a respective outgoing message to each of the one or more network addresses associated with the second client node;
receiving an incoming message from the second client node;
extracting network address information from the received incoming message, wherein the extracted network address information comprises a network address associated with the second client node;
comparing the extracted network address information with the network address information received from the server node;
based on a determination the extracted network address information is different from that the network address information received from the server node, transmitting the extracted network address information to the server node.

2. The method of claim 1, further comprising by the first client node maintaining an address register of network address information associated with the second client node, wherein the maintaining comprises incorporating into the address register all network address information received from the server node and all network address information extracted by the first client node from incoming messages received from the second client node.

3. The method of claim 2, wherein the network address register comprises different network addresses of associated with second client node, and the sending comprises sending a respective outgoing message to each of the network addresses in the address register at the time of the sending.

4. The method of claim 1, wherein the transmitting comprises transmitting the network address information in the address register to the server node.

5. The method of claim 1, wherein the sending comprises incorporating a respective unique identifier in each outgoing message to a respective one of the one or more network addresses associated with the second client node.

6. The method of claim 5, further comprising maintaining a mapping that associates each unique identifier with the respective network address to which the outgoing message containing the unique identifier is sent.

7. The method of claim 6, further comprising, based on a determination that the incoming message received from the second client node comprises a particular one of the unique identifiers, ascertaining the respective network address associated with the particular unique identifier in the mapping and establishing a peer-to-peer network connection with the ascertained network address associated with the second client node.

8. The method of claim 7, wherein the network address information received from the server node comprises multiple different network addresses associated with the second client node.

9. The method of claim 1, further comprising by the second client node:
receiving network address information associated with the first client node from the server node, wherein the network address information comprises one or more network addresses associated with the first client node;
sending a respective outgoing message to each of the one or more network addresses associated with the first client node;
receiving an incoming message from the first client node;
extracting network address information from the received incoming message, wherein the extracted network address information comprises a network address associated with the first client node;
comparing the extracted network address information with the network address information received from the server node;
based on a determination that the extracted network address information is different from that the network address information received from the server node, transmitting the extracted network address information to the server node.

10. The method of claim 9, wherein the sending by the first client node and the sending by the second client node are performed simultaneously.

11. A method in a network communication environment comprising at least one server node supporting realtime communications between client nodes, the method comprising by a first one of the client nodes:
from the server node receiving network address information associated with a second one of the client nodes, wherein the network address information comprises one or more network addresses associated with the second client node;
sending a respective outgoing message to each of the one or more network addresses associated with the second client node, wherein the sending comprises incorporating a respective unique identifier in each outgoing message to a respective one of the one or more network addresses associated with the second client node;
maintaining a mapping that associates each unique identifier with the respective network address to which the outgoing message containing the unique identifier is sent;
receiving an incoming message from the second client node;
based on a determination that the incoming message received from the second client node comprises a particular one of the unique identifiers,
ascertaining the respective network address associated with the particular unique identifier in the mapping, and
establishing a peer-to-peer network connection with the ascertained network address associated with the second client node.

12. The method of claim 11, wherein the sending by the first client node and the sending by the second client node are performed concurrently.

13. A method in a network communication environment comprising at least one server node supporting realtime communications between client nodes, the method comprising by the at least one server node:
for each of the client nodes, receiving network address information associated with the client node from the client node and from one or more other ones of the client nodes;
provisioning pairs of the client nodes to establish respective peer-to-peer connections with each other, wherein the provisioning comprises for each pair of client nodes, sending to each of the constituent client nodes of the pair all the network address information received for the other constituent client node of the pair.

14. The method of claim 13, wherein the provisioning comprises:
provisioning a first one of the client nodes to establish a peer-to-peer network connection with a second one of the client nodes, wherein provisioning the first client node comprises sending to the first client node the network address information associated with the second client node received from the second client node and received from one or more of the other client nodes; and
concurrently with the provisioning of the first client node, provisioning the second client node to establish a peer-to-peer network connection with the first client node, wherein provisioning the second client node comprises sending to the second client node the address information associated with the first client node received from the first client node and received from one or more of the other client nodes.

15. A method in a network communication environment comprising at least one server node supporting realtime communications between client nodes, the method comprising by the at least one server node:
from a first one of the client nodes receiving first network address information associated with the first client node, from a second one of the client nodes receiving second network address information associated with the second client node, and from a third one of the client nodes receiving third network address information associated with the first client node;
provisioning the first client node to establish a peer-to-peer network connection with the second client node, wherein provisioning the first client node comprises sending the second network address information to the first client node; and
provisioning the second client node to establish a peer-to-peer network connection with the first client node, wherein provisioning the second client node comprises sending the first network address information and the third network address information to the second client node.

16. The method of claim 15, wherein provisioning the first client node comprises sending the first client node a first station identifier that uniquely identifies the second client node, and provisioning the second client node comprises sending the second client node a second station identifier that uniquely identifies the first client node.

17. The method of claim 15, further comprising receiving additional network address information associated with the first client node from ones of the client nodes other than the first and second client nodes, wherein provisioning the second client node further comprises sending the additional network address information to the second client node.

18. The method of claim 15, further comprising provisioning the third client node to establish a peer-to-peer network connection with the first client node, wherein the provisioning comprises sending the second network address information and the third network address information to the third client node.

19. The method of claim 15, wherein each of the first, second, and third network address information respectively comprises at least one of a public network address of the first client node, a local network address of the first client node, and a virtual private network address of the first client node.

20. The method of claim 15, wherein each of the first, second, and third network address information comprises a respective connectionless transport protocol address and a respective protocol port identifier for a protocol port on the client node.
